(19) United States
(12) Patent Application Publication
(10) Pub. No.: US 2005/0230501 A1
(43) Pub. Date: Oct. 20, 2005

(54) Fuel injection nozzle

(75) Inventor: Stephan Haas, Mammendorf (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MAN ROLAND DRUCKMASCHINEN AG, OFFENBACH AM MAIN (DE)

(21) Appl. No.: 11/033,575

(22) Filed: Jan. 12, 2005

(30) Foreign Application Priority Data
Jan. 16, 2004 (DE) 10 2004 002 286.0

(51) Int. Cl. F02M 39/00

(52) U.S. Cl. 239/533.3

(57) ABSTRACT

A fuel injection nozzle having a nozzle needle which is held in a close position under the action of a biasing spring and which can be opened by the pressure of fuel to be injected from the nozzle. For appropriately controlling the discharge of fuel during part load and full load operation, a control piston is provided which can be acted upon or can be relieved from pressure by means of a pressure fluid for moving the control cylinder between one of two different axial positions which limit opening travel of the nozzle needle for one or more rows of injection nozzle holes for the particular operation. The nozzle has a relatively simple, space saving construction.

### FIELD OF THE INVENTION

The present invention relates generally fuel injection nozzles, such as those used in internal combustion engines, and more particularly, to a fuel injection nozzle having a nozzle needle that is spring biased against a valve seat under the action of a biasing spring and which can be opened by pressure of the injected fuel.

### OBJECTS AND SUMMARY OF THE INVENTION

It is an object of the present invention to provide a fuel injection nozzle which is relatively simple and space saving in construction, and which can be efficiently operated in two different operating conditions, depending upon whether full load or part load operation is required. A further object to provide such a fuel injection nozzle which is adapted for general use and is not limited to a special injection system.

According to the invention, a fuel injection nozzle is provided that has a control piston that can be acted upon by fluid pressure or can be relieved from pressure in order to transfer the control piston to one of two different axial positions, each of which limits the opening movement of the nozzle needle a different distance dependent upon the number of rows of fuel injection nozzle discharge holes are to be utilized in injecting fuel. The nozzle is constructed and sized so it can be accommodated within the contour of conventional fuel injection nozzles.

In a preferred embodiment, the control piston has an end face that faces away from the nozzle needle, which preferably is pressurized when in a part-load position for limiting opening travel of the nozzle needle a distance which opens a single row of injection nozzle holes, and which is relieved from pressure in a full load position, for opening a plurality of rows of injection nozzle holes.

According to a further preferred embodiment of the invention, the control piston, when in the part load position, has an end face in the direction of the valve needle that bears against a fixed stop in the housing of the nozzle. When the control piston is in the full load position, the end face which faces away from the nozzle needle bears against a further stop fixed in the housing. This results in precisely defined operating positions for the two different load conditions

Other objects and advantages of the invention will become apparent upon reading the following detailed description and upon reference to the drawings, in which:

### BRIEF DESCRIPTION OF THE DRAWINGS

FIG. 1 is a vertical section of a fuel injection nozzle in accordance with the invention which utilizes fuel as a pressure fluid for controlling the operating condition of the nozzle; and

FIG. 2 is a vertical section of an alternative embodiment fuel injection nozzle according to the invention which utilizes lubricating oil as a pressure fluid for controlling the operation condition of the nozzle.

While the invention is susceptible of various modifications and alternative constructions, certain illustrated embodiments thereof have been shown in the drawings and will be described below in detail. It should be understood, however, that there is no intention to limit the invention to the specific forms disclosed, but on the contrary, the intention is to cover all modifications, alternative constructions and equivalents falling within the spirit and scope of the invention.

### DETAILED DESCRIPTION OF PREFERRED EMBODIMENT

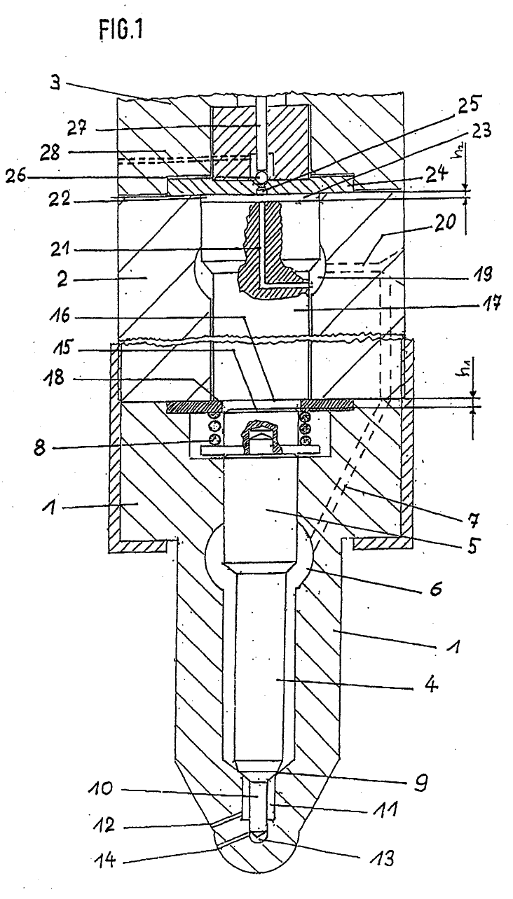

Referring now more particularly to FIG. 1 of the drawings, there is shown an illustrative fuel injection nozzle in accordance with the invention, such as the type that is operable for injecting fuel into an internal combustion engine. The illustrated has a housing composed of three axially abutting parts 1, 2, 3 within which a nozzle needle 4 is disposed for relative axial movement. The nozzle needle 4 in this case has an enlarged diameter section 5 guided for axial displacement in the housing. The enlarged diameter section 5 protrudes into a pressure space or chamber 6 disposed in circumferential surrounding relation to the nozzle needle 4, which in turn communicates with an annular space about a downstream smaller diameter section of the needle 4. Fuel which is to be injected is fed via a fuel line or port 7 to the pressure chamber 6 for travel downstream about the reduced diameter section of the nozzle needle 4. The lower or downstream end of the nozzle needle, when in a closed or non-operating position, bears against a valve seat 9 under the action of a biasing spring 8.

Located at the end of the valve needle 4 is a control pin 10 which passes through an annular connecting space 11 defined by a cylindrical wall greater in diameter than the control pin 10. A first row of injection-nozzle discharge holes 12 communicate with the connecting space 11 through the lower housing part 1. The lower most terminal end of the control pin protrudes in sealing relation into a further smaller diameter connecting bore or space 13 into which at least one further row 14 of injection-nozzle discharge holes communicate.

In the inoperative position illustrated in FIG. 1, the nozzle needle 4, which in this case has a two-part construction, has an upper surface 15 situated a distance h1 from a lower end surface of a control piston 17, which is supported by the housing part 3 for relative axial movement. The control piston 17 has a lower end face 16 which bears against an annular stop 18 fixed on the housing. The control piston 17 extends upwardly through an annular chamber 19 defined between the lateral periphery of the control piston 17 and the housing part 2. The annular chamber 19 in turn is connected via a line 20 to the fuel conducting line 7. The control piston 17 is formed with an internal line 21 that leads from the control chamber 19 to a pressure space 22 above an upper end surface 23 of the control piston 17 defined by a plate-shaped stop 24 and lateral sides of the housing part 2.

The stop 24 has a central bore 25 which can be closed by a closure element, which in this case includes a closure ball 26 that can be held in a closed position by means of an axially extending adjusting rod 27. The adjusting rod 27 is selectively adjustable as a function of the loading on the engine such that, in the inoperative position and in a part load operating position, the closure ball 26 is held in the closed position and, in a full load position for the engine the rod 27 is moved upwardly so that the closure ball opens to allow fuel to flow through a line 28. It will be understood that alternative closure elements which can be opened and closed as a function of the engine power also can be used.

If, in the setting for the part-load operation, in which the closure element 26, 27 is closed, fuel is conducted under pressure through the line 7, and pressure likewise builds up into the pressure space 22 via the lines 20, 21 and presses the control piston 17 against the stop 18. At the same time, the nozzle needle 4 is lifted from the seat 9 until its upper end surface 15 bears against the lower end surface 16 of the control piston. With appropriate dimensioning, on the one hand, of the surfaces transferring the nozzle needle 4 into the opening movement and, on the other hand, of the upper end surface 23 of the control piston, the control piston 17 remains bearing against the stop 18 as a consequence of the pressure in the pressure space 20. The nozzle needle 4 can therefore move only by the distance h1 such that fuel emerges from the injection-nozzle holes 12 via the annular collecting space 11.

When the adjusting rod 27 is moved to the full-load operating position, it opens up the closure ball 26. The fuel now passes through the lines 20, 21 into the pressure space 22 and flows off via the line 28, thereby relieving pressure in the space 22. The control piston 17 can therefore additionally move by the distance h2 until it bears against the stop 24, and this movement is followed by the nozzle needle 4. In the process, the control pin 10 exits from the collecting space 13 allowing fuel to additionally pass to the injection-nozzle holes 14.

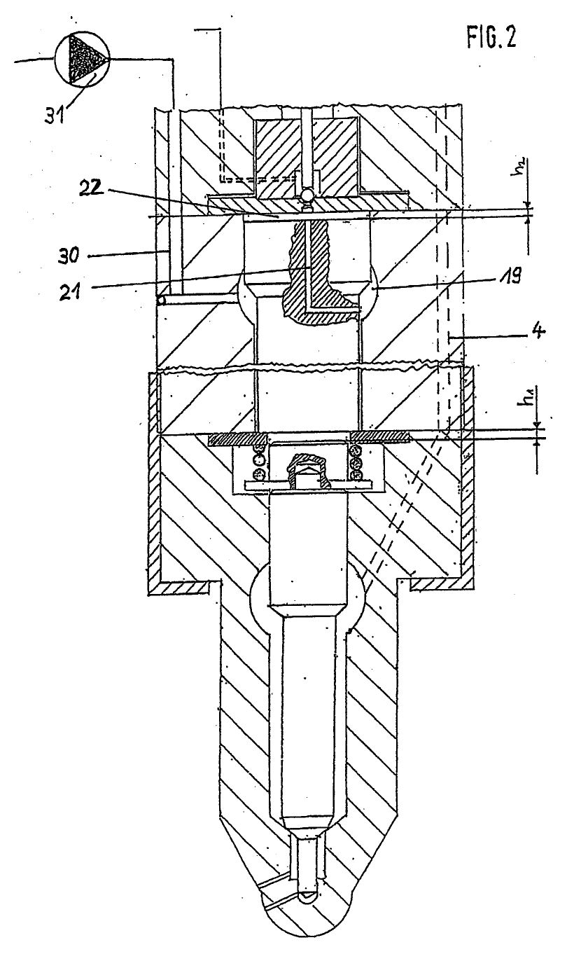

An alternative embodiment of the injection nozzle is depicted in FIG. 2 which has a substantially similar construction to that described above. The sole difference is that instead of using fuel as a pressure medium, the chamber 19 is connected to a line 30 to which lubricating oil is fed under pressure by means of a pump 31. This lubricating oil then passes via the line 21 into the pressure space 22. The further functioning corresponds with the arrangement from FIG. 1. It will be understood that alternatively the pressure space 22 could be pressurized with a pressure fluid from a separate liquid supply circuit.

1. A fuel injection nozzle comprising:
a housing having a valve seat,
a nozzle needle disposed for axial movement in said housing for controlling the discharge of fuel from the nozzle for both part load operation and full load operation,
a biasing member for urging said needle in a closed position against said seat, said needle being axially moveable in an opening direction away from said valve seat against the force of said biasing member,
said housing having a discharge end portion defining a plurality of rows of injection nozzle holes (12), (17), and
a control piston (17) axially moveable to one of two different axial positions in said housing in response to being acted upon by a pressure fluid and being relieved from pressure by said pressure fluid for limiting opening movement of said nozzle needle away from said valve seat to a first position that opens at least one row said injection nozzle holes and a second position that opens more than said least one row of injection nozzle holes.

2. The fuel injection nozzle of claim 1 in which said control piston has a first end face (23) which faces away from said nozzle needle (4) that is acted upon by said pressure fluid to position said control piston (17) in a part load position which limits opening travel of the nozzle needle to a position that opens said at least one row of injection nozzle holes (12) and which when relieved from pressure from said pressure fluid the control piston is allowed to move to a full load position which opens said more than at least one row of injection nozzle holes.

3. The fuel injection nozzle of claim 2 in which said housing includes a first fixed stop (18) and said control piston (17) has a second end face (16) that faces said nozzle needle (4) and bears against said first fixed stop when in said part load position.

4. The fuel injection nozzle of claim 3 in which said housing includes a second fixed stop, and said control piston has a second end face 23 which faces away from said nozzle needle (4) that bears against said second fixed stop when said control piston is in said full load position.

5. The fuel injection nozzle of claim 4 in which said housing and second end face (23) of said control piston define a pressure space (23) which can be charged with a pressure fluid to maintain the control piston (17) in said part load position and which can be relieved from pressure to permit movement of said control piston to said full load position.

6. The fuel injection nozzle of claim 5 in which pressure fluid to said pressure space (22) is controlled by a closure element (26), (27) as a function of part load or full load operation.

7. The fuel injection nozzle of claim 6 in which said housing and control piston define an annular chamber (19) about said control piston into which pressure fluid can be directed, and said control piston (17) is formed with a line (21) communicating between said annular chamber (19) and said pressure space (22).

8. The fuel injection nozzle of claim 6 in which said closure element (26) (27) includes an adjusting rod (27) and a closure ball (26), said closure ball (26) being held in a pressure fluid closing position when said control piston (17) is in the part load position, and said adjusting rod (27) being moveable to permit movement of said closure ball (26) to an open position to relieve pressure in the pressure space (22) for permitting movement of the control piston (17) to said full load position.

9. The fuel injection nozzle of claim 1 in which said pressure fluid is fuel that is to be injected by said nozzle.

10. The fuel injection nozzle of claim 1 in which said pressure fluid is lubricating oil.

11. The fuel injection nozzle of claim 1 in which said pressure fluid is a lubricating oil, and including a pump for increasing the pressure of said pressure fluid.

12. The fuel injection nozzle of claim 1 in which said nozzle needle and housing define an annular collecting space (11) communicating with said at least one row (12) of the fuel injection hole, and a second annular collecting space communicating with an additional row (14) of fuel injection holes, and when said control piston (17) is in said part load position said nozzle needle has a needle portion extending in sealed relation with said second collecting space (13) for preventing the communication of fuel to said further row of the injection nozzle holes, and when said control piston is in said full load position said nozzle needle portion is removed from said second collecting space to allow the flow of fuel to said further row of fuel injection holes.

13. A fuel injection nozzle for injecting fuel in an internal combustion engine during part load and full load operation comprising:
a housing having a valve seat,
a nozzle needle disposed for axial movement in said housing for controlling the discharge of fuel from the nozzle for both part load operation and full load operation,
a biasing member for urging said needle in a closed position against said seat, said needle being axially moveable in an opening direction away from said valve seat against the force of said biasing member,
said housing having a discharge end portion defining a plurality of rows of injection nozzle holes (12), (17), and
a control piston (17) having a first end face adjacent an upper end face of said nozzle needle, said control piston and nozzle needle end faces defining a pressure space into which pressure fluid may be directed, said control piston (17) being axially moveable and retained in a first axial position in response to pressure fluid directed into said pressure space for limiting opening movement of said nozzle needle away from said valve seat to a first position that opens at least one row of said injection nozzle holes, and said control piston being moveable to a second axial position in response to said pressure space being relieved of pressure from said pressure fluid for enabling opening movement of said valve needle to a second position that opens more than said at least one row of injection nozzle holes.
